(19) United States
(12) Patent Application Publication
(10) Pub. No.: US 2008/0164775 A1
(43) Pub. Date: Jul. 10, 2008

(54) Electromotive Drive

(76) Inventor: Helmut Sesselmann, Steinach (DE)

Correspondence Address: CHRISTIE, PARKER & HALE, LLP, PO BOX 7068, PASADENA, CA, 91109-7068, US

(21) Appl. No.: 11/885,617

(22) PCT Filed: Feb. 28, 2006
(86) PCT No.: PCT/DE06/00385

§ 371 Date: Aug. 31, 2007

(30) Foreign Application Priority Data
Mar. 1, 2005 (DE) 10 2005 009 116.4

(51) Int. Cl. H02K 7/116; F16H 29/20

(52) U.S. Cl. 310/83; 74/89.14; 310/44

(57) ABSTRACT

An electromotive drive for a motor vehicle is provided. The electromotive drive comprising an armature which is located on a rotor shaft, a tube element with magnetic shells which are fitted to the inner faces, and elements which are fitted to the ends of the tube and support the rotor shaft. Means are provided by means of which elements which support the rotor shaft are aligned in relation to the magnetic shells.

### CROSS-REFERENCE TO A RELATED APPLICATION

This application is a National Phase Patent Application of International Patent Application Number PCT/DE2006/000385, filed on Feb. 28, 2006, which claims priority of German Patent Application Number 10 2005 009 116.4, filed on Mar. 1, 2005.

### BACKGROUND

The invention relates to an electromotive drive.

Electromotive drives are used in motor vehicles, inter alia in window winders, drives for sliding doors or in seat adjustment systems. One example of such a drive is described in DE 201 11 575 U1.

Known electric motors in the form of DC bar armature motors have a pole pot which is composed of metal and is produced by deep drawing in a plurality of drawing stages. The magnets of the stator are fastened in the pole pot, which has to be produced very accurately, by means of clamping or adhesive bonding in order to prevent parasitic air gap losses in the region of the bearing surfaces of the magnets in relation to the pole pot. The cross sections of known pole pots are not matched to the different radially acting flow densities (saturation in iron).

U.S. Pat. No. 5,924,668 discloses an electromotive drive for a motor vehicle which drives a seat adjustment system. This drive comprises an armature which is located on a rotor shaft, a tube element with magnetic shells which are fitted to the inner faces, and elements which are fitted to the ends of the tube and support the rotor shaft. The elements which support the rotor shaft are aligned with respect to the tube element.

### SUMMARY

The object of the present invention is to develop an electromotive drive for a motor vehicle.

According to the invention, means are provided by means of which elements which support the rotor shaft are aligned and centered in relation to the magnetic shells. The magnets (field magnets) of the tube element are applied/injected on the inner face of the tube element as magnetic particles bound in plastic. Plastic-bound rare earth magnets are preferably used. The injection process—injection molding with polyamides, in particular a modified temperature-stable polyamide—permits mechanical accuracies of a few hundredths of a millimeter to be achieved. Costly refinishing work—for example grinding in the case of sintered magnetic materials—is dispensed with. The injection molding method permits complex shaping in virtually any desired manner, it being possible to realize additional mechanical functions. Method steps for fastening magnetic shells—extrusion coating with adhesives, fastening magnetic shells with metal parts—can be dispensed with. The use of rare earth magnets bound in plastic reduces the losses due to eddy currents—the relative density is likewise reduced. The tube element which is composed of steel can be continuously drawn with a flow-optimized cross section. Furthermore, it is likewise possible to roll the tube element which accommodates the magnets from a semifinished product (strip).

According to one exemplary embodiment of the invention, it is possible to produce the tube element from two half-shells. In this case, provision may then be made to connect these half-shells by means of the injected plastic material which forms the magnet poles. Instead of or in addition to the connection of the half-shells by means of the injected plastic magnets, an interlocking, force-fitting or frictional connection technique can be employed for the half-shells.

The elements which support the rotor shaft and are aligned and centered with respect to the magnetic shells are preferably in the form of plastic parts and form a bearing flange and a gear mechanism flange. These possess the envisaged bearing elements. The use of plastic at the two ends of the pole tube results in a saving in steel and therefore also in weight—in a conventional pole pot which is produced by deep-drawing, the base with the cup bearing seat of the mount of the rotor shaft and also the front flange region for the connected gear mechanism are likewise composed of steel.

The bearing and gear mechanism flange can be of one-piece or two-piece design. In the case of one-piece configuration of the flange, the bearing for the rotor shaft is integrated directly in this bearing. In the case of a two-piece design of the flange, the bearing for the shaft is inserted into an additional flange or a cup bearing seat, which can be inserted separately, in the flange. In addition, an electronics system in the form of a printed circuit board can also be accommodated in the flange. In order to hold the bearing, this printed circuit board then has a cutout in the region of the motor shaft mount.

The tube element which is provided according to the invention and holds the magnetic elements which are bound in plastic does not have to be a precisely produced shaped part—the wall thickness of the steel or of the tube halves is matched to the magnetic flux. The tube body therefore has the function of optimum flux guidance and of carrying the injected magnets which are bound in plastic. The required accuracy of the inner magnet casing in relation to the armature (inside diameter and concentricity in relation to the axis of the rotor shaft—produced by an injection mold during injection of the magnetic plastic material) is transferred to the injected magnetic body which, at its end face, has an alignment structure which interacts in an interlocking manner with a corresponding mating mold on the element (bearing flange, gear mechanism flange). To this end, end faces of the plastic-based magnetic shells can be designed conically or stepped in the form of a mold shoulder. The elements (bearing flange, gear mechanism flange) which complete the tube element and support the shaft have a correspondingly designed mating contour by means of which the elements and therefore the position of the rotor are exactly aligned centrally with respect to the magnetic shells.

Sputtering the magnetic shells into the element results in complete application of the magnetic material on the steel tube wall—inhomogeneities and air gaps between the magnetic material and the steel tube wall are prevented. The above-described alignment of the rotor shaft and therefore of the armature with respect to the magnetic shells results in a highly accurate air gap between the magnetic shells and armature. Power losses and harmful vibrations are avoided.

In order to securely fasten the injected magnetic shells on the inner wall of the pipe, the pipe element has, according to one preferred development of the invention, undercuts or shaped stamped areas. Corresponding configuration of these shaped stamped areas provides additional interlocking fastening in addition to adhesion of the magnetic plastic.

According to a further exemplary embodiment of the invention, seals are inserted into the bearing and the gear mechanism flange. Seals with a two-component plastic can also be provided between the bearing flange or gear mechanism flange and the tube element. In addition to sealing, this also provides acoustic decoupling—the motor according to the invention runs with less noise.

According to one exemplary configuration of the invention, the rotor shaft has a worm at one end. A cable drum of a cable window winder can then be driven by means of this worm via a worm gear and, if necessary, a further spur gear stage. Other adjustment devices within a motor vehicle can also be operated together with the worm gear by means of the worm.

In the embodiment of the rotor shaft with a worm at one end, the rotor shaft is preferably mounted at both ends of the rotor armature. Accordingly, the bearing flange and also the gear mechanism flange, which guides the rotor shaft, each have a bearing. The worm which is seated on the other side of the gear mechanism flange is preferably mounted in a cantilevered manner in the case of short design. In the case of a longer worm, a further bearing support of the shaft can additionally be provided.

The bearing flange and gear mechanism flange are preferably held together by two steel clips which run outside the tube element. To this end, the gear mechanism flange and bearing flange have fastening niches into which the ends of the clips engage in each case. Provision is preferably made for the tube element to be flattened precisely in those regions in which the ends of the bearing shells are opposite one another. The bearing flange and gear mechanism flange are then connected in this region by means of the steel clips. The steel clips then not only hold the two flanges at the respective ends of a tube element but the steel clips also increase the flow cross section in this exposed region of the tube element (high saturation induction).

The ends of the steel clips can be in the form of hooks which engage in corresponding niches in the bearing flange and/or gear mechanism flange. It is also possible to form the clips which are arranged on both sides of the tube element as a U-shaped clamp, with the limbs of this clamp running along the tube element and the center region of the clamp surrounding the bearing flange. Furthermore, it is also possible to design the clips as a steel strip in each case, with the ends of the strips each passing to a slot opening in the bearing flange and in the gear mechanism flange and the protruding ends being deformed. The described embodiments of and ways of fastening the steel clips or strips can also be combined with one another.

### BRIEF DESCRIPTION OF THE DRAWINGS

Exemplary embodiments of the invention are furthermore explained with reference to the figures, in which:

FIG. 1 shows an external view of the drive according to the invention with a worm.

FIG. 2 shows the tube element with magnetic shells and armature.

FIG. 3 shows the tube element with a worm which is fitted to the rotor shaft and with a bearing flange together with an electronics unit.

FIG. 4 shows the subject matter according to FIG. 3 without the tube element.

FIG. 5 shows a first variant for centering of the flange with respect to the magnetic shells of the tube element.

FIG. 6 shows a second variant for centering of the flange with respect to the magnetic shells of the tube element.

FIG. 7 shows a first fastening option for the gear mechanism and bearing flange.

FIG. 8 shows a second fastening option for the gear mechanism and bearing flange.

FIG. 9 shows a third fastening option for the gear mechanism and bearing flange.

FIG. 10 shows a forth fastening option for the gear mechanism and bearing flange.

FIG. 11 shows a variant for fitting the steel clip, the clamp or the steel strip.

### DETAILED DESCRIPTION

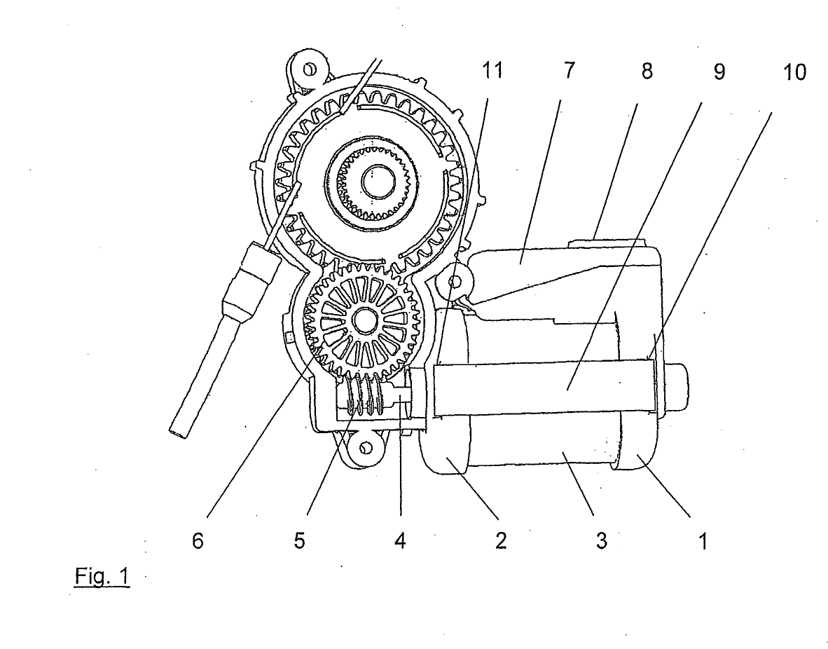

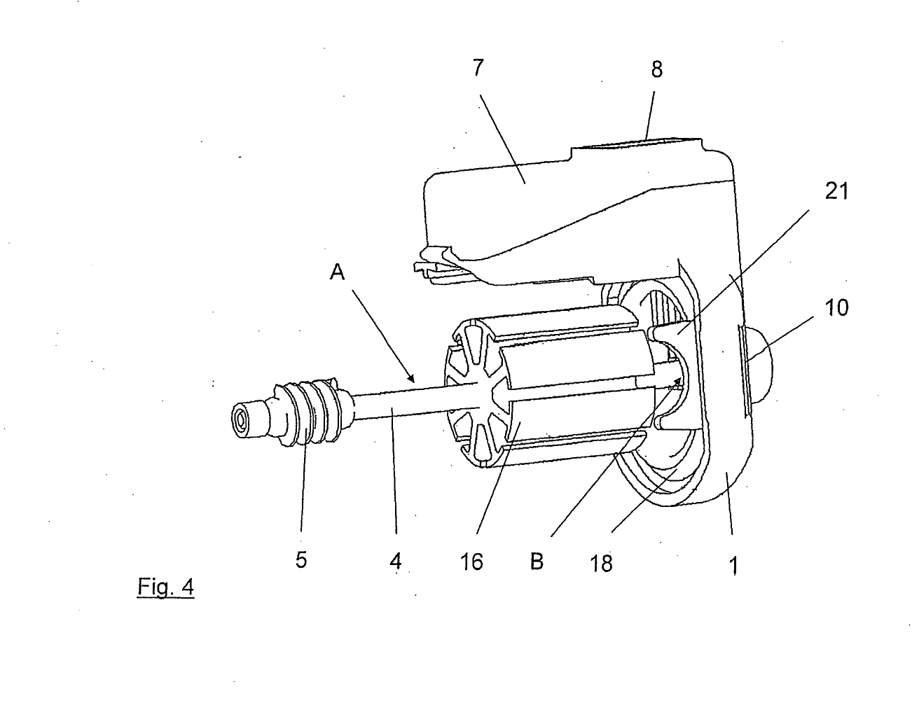

FIG. 1 shows an external view of the drive according to the invention. A rotor shaft 4 which is mounted in a bearing flange 1 and a gear mechanism flange 2 has, at one end, a worm 5 which drives a cable drum (not illustrated) of a cable window winder via a worm gear 6 and a downstream spur gear stage. The bearing flange 1 additionally has an electronics unit 7 with a plug connection 8. The bearing flange 1 and gear mechanism flange 2 which are composed of plastic are each fitted to the end of a tube element 3 which surrounds the armature (not illustrated here) and are held by two steel clips 9 whose angled ends engage in fastening niches 10, 11. The flanges 1, 2 have elements (not illustrated) which support the rotor shaft 4 and are in the form of sliding or rolling bearings. In FIG. 4, A and B denote the bearing points of the rotor shaft 4.

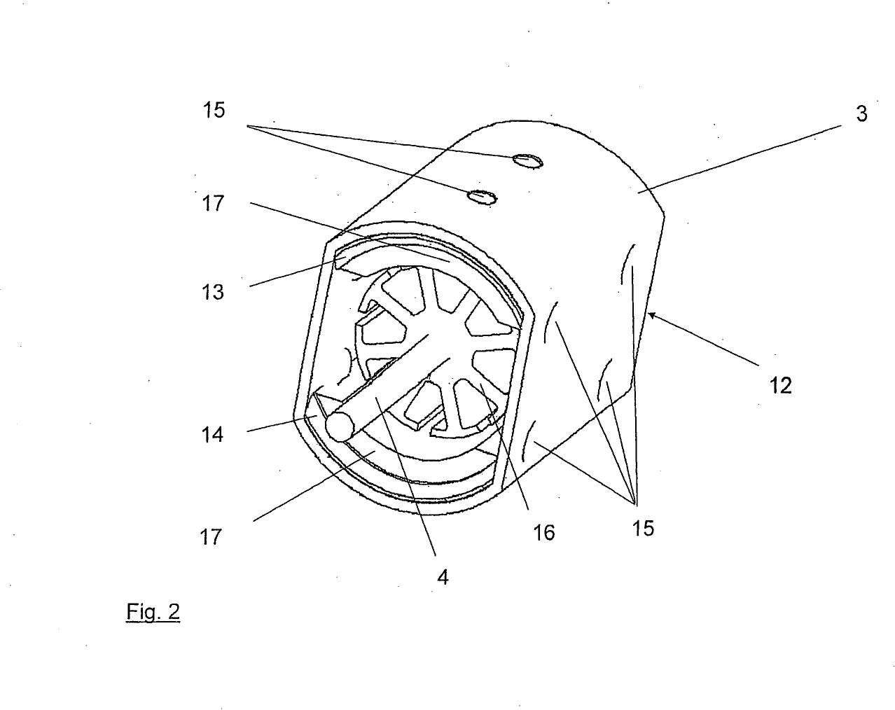

The tube element is in the form of a steel tube 3 which is flattened on two opposite sides (FIG. 2). Magnetic shells 13, 14 which are composed of a magnetic material which is bound in plastic are fitted to the inner concave regions between the flattened areas 12 by means of an injection molding method. The outer region of the tube is provided with shaped stamped areas 15 which additionally hold the sputtered magnetic shells on the inner face of the tube 3. In the tube 3, an armature 16 which is fitted on the rotor shaft 4 interacts with the magnetic shells 13, 14 in a manner which is known per se.

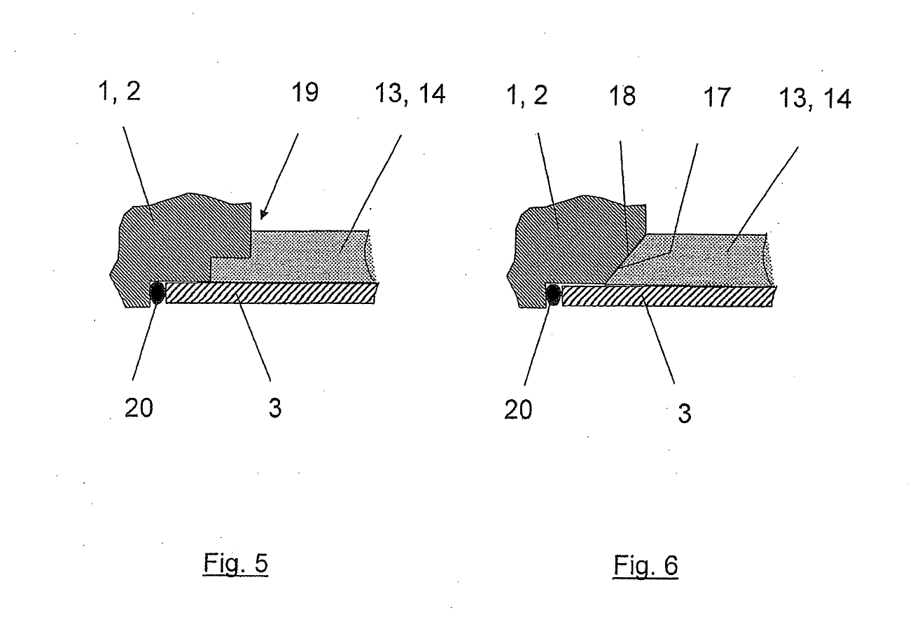

FIGS. 2, 3, 4 and 6 illustrate conical centering surfaces 17 on the magnetic shells and the centering surfaces 18 on the bearing flange 1 and gear mechanism flange 2 which are formed in a corresponding manner to said centering surfaces 17. These centering surfaces 17, 18 align the flanges 1, 2 which support the rotor shaft 4 and therefore the armature 16 on the rotor shaft 4 with respect to the magnetic shells 13, 14. In this case, FIG. 5 shows one variant for centering the bearing flange 1 and gear mechanism flange 2 with respect to the magnetic shells 13, 14. Here, centering is performed by a stepped region 19 on the end face of a magnetic shell 13, 14 with a contour, which is formed in a corresponding manner to this stepped region, on the bearing flange 1 or gear mechanism flange 2. Both in the variant according to FIG. 5 and that according to FIG. 6, a sealing element 20 is inserted between the bearing flange 1 or gear mechanism flange 2 and the end of the tube 3.

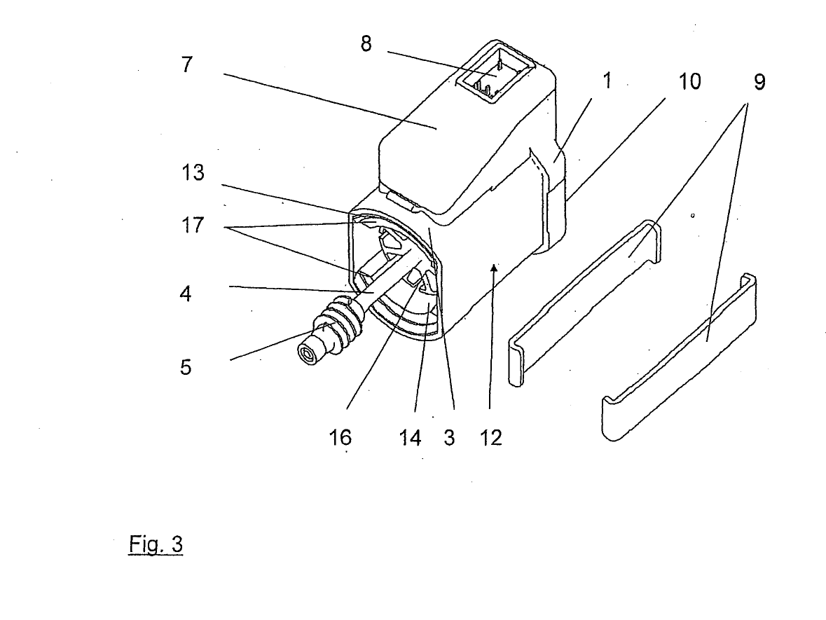

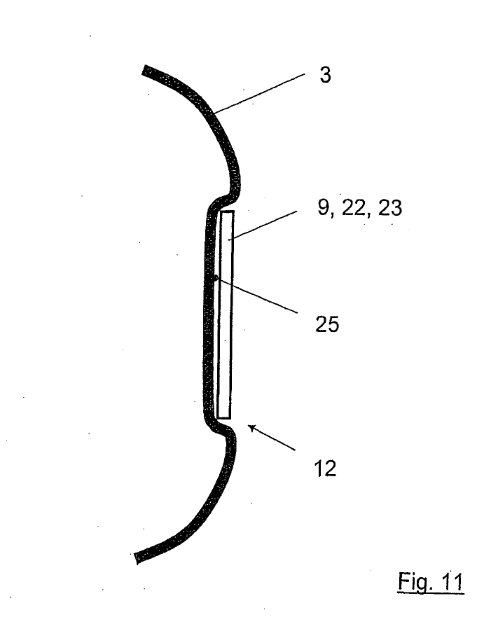

FIG. 3 shows the tube 3 with the two injected magnetic shells 13, 14, the armature 16 which is located between said magnetic shells, the rotor shaft 4 and the worm 5. The gear mechanism flange 2 according to FIG. 1 is omitted in this illustration. The bearing flange 1, which includes the electronics part 7 which is seated on the upper face of the tube 3 and has a plug connection 8 for connection to a vehicle electronics system (not illustrated), is fitted to the rear end of the tube. FIG. 3 likewise shows the two steel clips 9 which flank the tube 3 on the flattened sides 12. The ends of the clips 9 interact on each side with in each case one fastening niche 10, 11 on the bearing flange 1 or gear mechanism flange 2. FIG. 4 shows one of the fastening niches 10 on the bearing flange 1. Said FIG. also shows the centering surface 18 on the bearing flange 1 and a guide lug 21 which is inserted between the two magnetic shells 13, 14 in the flattened region of the tube 3. Fastening of the bearing flange 1 and gear mechanism flange 2 on the tube 3 by means of the steel clips 9 in the manner described here is likewise shown in FIG. 10.

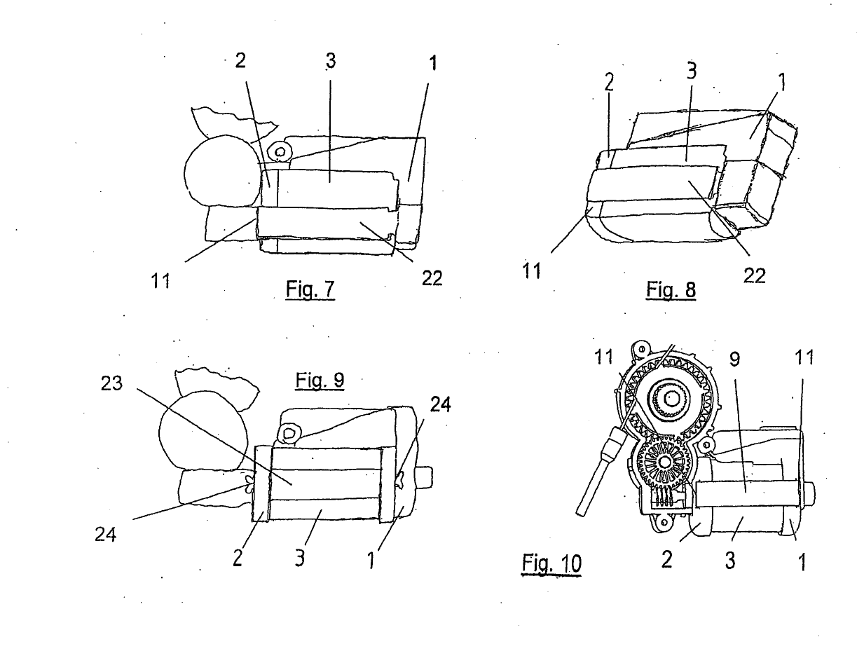

In the variant according to FIGS. 7 and 8, the two steel clips 9 according to FIG. 10 are combined to form a clamp 22 whose center region surrounds the rear bearing part 1. The front ends of the clamp interact with a respective fastening niche 11 in the gear mechanism flange 2, as in the variant according to FIG. 10.

According to FIG. 9, the bearing flange 1 and gear mechanism flange 2 are fastened to the tube 3 by means of two steel strips 23 which flank both sides of the tube 3 in the region of its flattened area 12 and whose ends are inserted through slots 24 in the bearing flange 1 and gear mechanism flange 2. The ends of the steel strips 23 are bent or turned in envisaged regions. The envisaged tensile forces for fastening the bearing flange 1 and gear mechanism flange 2 to the tube 3 are generated as a result.

FIG. 11 shows a variant for fitting the steel clip 9, the clamp 22 or the steel strip 23. In the region of the two opposite flattened areas 12, the tube 3 has a recess 25 into which the steel clip 9, the clamp 22 or the steel strip 23 can be placed. In this case, the recess is dimensioned in such a way that the upper face of the steel clip 9, clamp 22 or steel strip 23 terminates flush with the flattened area.

1-19. (canceled)

20. An electromotive drive for a motor vehicle, comprising an armature which is located on a rotor shaft, a tube element with magnetic shells which are fitted to the inner faces, and elements which are fitted to the ends of the tube and support the rotor shaft, wherein means are provided by means of which elements which support the rotor shaft are aligned in relation to the magnetic shells.

21. The electromotive drive of claim 20, wherein the magnetic shells have, on an end face, conical centering surfaces which interact with correspondingly formed centering surfaces on the element which is associated with this face.

22. The electromotive drive of claim 20, wherein the magnetic shells have, on an end face, a stepped region which interacts with correspondingly formed surfaces on the element which is associated with this face.

23. The electromotive drive of claim 20 or 21, wherein the element has a guide lug which protrudes into the tube on the inside of the tube.

24. The electromotive drive of claim 23, wherein the guide lug protrudes into the tube between the magnetic shells.

25. The electromotive drive of claim 20, wherein the tube has flattened areas in the region of the opposing magnetic shells.

26. The electromotive drive of claim 20, wherein the magnetic shells are inserted into the tube by means of an injection molding method.

27. The electromotive drive of claim 26, wherein the material of the magnetic shells contains magnetic particles which are bound in plastic.

28. The electromotive drive of claim 26, wherein the magnetic shells contain rare earths which are bound in plastic.

29. The electromotive drive of claim 26, wherein the tube has stamped shaped areas which carry the magnetic shells.

30. The electromotive drive of claim 20, wherein the elements which support the rotor shaft are in the form of a bearing flange and a gear mechanism flange with a downstream gear stage.

31. The electromotive drive of claim 30, wherein the rotor shaft has a worm which interacts with a worm gear.

32. The electromotive drive of claim 20, wherein the bearing flange includes an electronic part.

33. The electromotive drive claim 20, wherein the elements which support the rotor shaft are connected to one another by means of a clip whose ends each engage in a fastening niche.

34. The electromotive drive of claim 20, wherein the elements which support the rotor shaft are connected to one another by means of a clamp which surrounds the bearing element.

35. The electromotive drive of claim 20, wherein the elements which support the rotor shaft are connected to one another by means of strips which pass through a slot in the respective elements.

36. The electromotive drive of claim 33, wherein the clip, which connects the elements, is composed of steel.

37. The electromotive drive of claim 34, wherein the clamp is composed of steel.

38. The electromotive drive of claim 35, wherein the strip is composed of steel.

39. The electromotive drive of claim 33, wherein the clips, which connect the elements, are arranged in the region of the flattened areas of the tube.

40. The electromotive drive of claim 34, wherein the clamp is arranged in the region of the flattened areas of the tube.

41. The electromotive drive of claim 35, wherein the strips are arranged in the region of the flattened areas of the tube.

42. The electromotive drive of claim 39, wherein the clips, which connect the elements, are arranged in recesses which are made in the region of the flattened areas of the tube.

43. The electromotive drive of claim 40, wherein the clamp is arranged in recesses which are made in the region of the flattened areas of the tube.

44. The electromotive drive of claim 41, wherein the strips are arranged in recesses which are made in the region of the flattened areas of the tube.
